(19) United States
(12) Patent Application Publication
(10) Pub. No.: US 2008/0312108 A1
(43) Pub. Date: Dec. 18, 2008

(54) Compositions and process for recovering subterranean oil using green non-toxic biodegradable strong alkali metal salts of polymerized weak acids

(76) Inventors: Paul Daniel Berger, Sugar Land, TX (US); Christie Huimin Berger, Sugar Land, TX (US)

Correspondence Address: PAUL BERGER;C/O OCT, 12822 PARK ONE DRIVE, SUGAR LAND, TX, 77478, US

(21) Appl. No.: 11/811,786

(22) Filed: Jun. 12, 2007

(51) Int. Cl. C09K 8/58

(52) U.S. Cl. 507/213; 507/244

(57) ABSTRACT

Compositions and process for recovering of oil from subterranean oil-bearing reservoirs consisting of green non-toxic biodegradable strong alkali metal salt of polymerized weak acids, one or more surfactants, an aqueous fluid, a optionally one or more mobility control agents and optionally one or more co-solvents are disclosed. Such compositions are injected into the reservoir through one or more injection wells and assist in recovering trapped oil through one or more producing wells.

A preferred green non-toxic biodegradable strong alkali metal salt of polymerized weak acids is the sodium salt of polyaspartic acid shown below where n is 10 to 50.

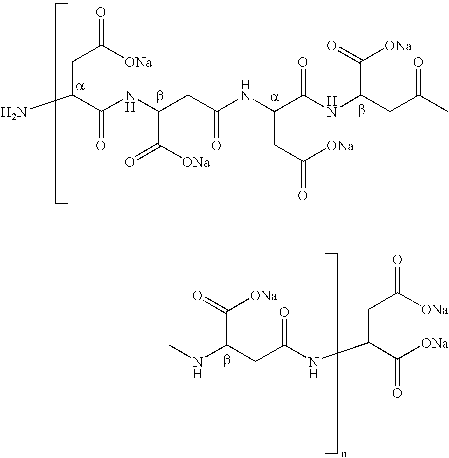

The compositions and the process of the present invention offer the advantage of improved compatibility with unsoftened waters, surfactants, and various mobility control agents. The green non-toxic, biodegradable properties of the alkali makes it particularly suitable for environmentally sensitive applications such as offshore and inland lakes.

### CROSS REFERENCE TO RELATED APPLICATIONS

None

### BACKGROUND OF THE INVENTION

This invention relates to compositions containing green non-toxic biodegradable strong alkali metal salts of polymerized weak acids, and a process for recovering oil from subterranean oil-bearing reservoirs employing such compositions.

Crude oil is recovered from oil-bearing reservoirs generally by three processes designated primary, secondary and tertiary recovery. In primary recovery the oil is produced through a producing well by taking advantage of the pressure exerted on underground pools of oil by gas or water present with the oil. Approximately 20% of the original oil in place (OOIP) is recovered by this process. Once this pressure has been exhausted other means of recovering the remaining oil must be employed. In secondary recovery the well may be re-pressurized with gas or water injected through one or more injection wells to recover approximately an additional 20% of the OOIP. Other secondary recovery methods include acidizing and/or fracturing to create multiple channels through which the oil may flow. After secondary recovery means have been exhausted and fail to produce any additional oil, tertiary recovery can be employed to recover additional oil up to approximately 60% OOIP. Tertiary oil recovery processes include, but are not limited to, steam flooding, polymer flooding, and chemical flooding.

Chemical flooding includes the use of surfactants for lowering the interfacial tension (IFT) between the injection brine and the residual oil. Mobility control agents such as polymers are usually employed along with surfactants to adjust the mobility ratio between the oil and the injection brine. It has also been found that alkali, when included in the injection brine, can react with the acidic material present in the trapped oil to form surface-active salts that enhance the effectiveness of the injected surfactant. Alkali also is preferentially adsorbed onto the reservoir and therefore reduces the loss of surfactant and polymer through adsorption. Alkaline-Surfactant-Polymer Flooding (ASP) has been the subject of numerous studies, papers and patents, for example U.S. Pat. No. 4,004,638 issued to Burdyn et al. in 1977. Several other tertiary chemical processes for enhanced oil recovery include Alkaline Surfactant (AS), Alkaline Polymer (AP), and Alkaline flooding. The alkali commonly used in these applications are inorganic alkali including, but are not limited to, sodium hydroxide, sodium carbonate, the combination of sodium hydroxide and sodium carbonate, and sodium silicates.

Inorganic alkali has several shortcomings. Inorganic alkali may cause corrosion problems in the injection and producing equipment. Inorganic alkali will react with divalent cations present in the injection and connate brine to form scale and precipitate that consumes the alkali and also may plug and damage the reservoir. Inorganic alkali may also react with surfactants and polymers, reducing their effectiveness and requiring the use of additional materials to make up for the loss. To resolve incompatibility problems, the injection water is sometimes softened, however, water softening is a costly process and often reduces the economic attractiveness of the process. These deficiencies are discussed in SPE 80532 “An Extended Field Test Study on Alkaline-Surfactant-Polymer Flooding in Beiyiduanxi of Daqing Oilfield”.

To alleviate the problems, Holm and Robertson in SPE 7583 entitled “Improved Micellar-Polymer Flooding with High pH Chemicals”, describe the use of the sodium salt of ethylene-diamine tetraacetic acid (EDTA) as a substitute for conventional inorganic alkali such as sodium silicate or sodium hydroxide. EDTA was found to be an effective additive as a replacement for inorganic alkali; however, one of the disadvantages of EDTA is that EDTA is not biodegradable and is environmentally unfriendly. Also, a one to one molar ratio of the EDTA to divalent cations is needed which could be very costly for higher divalent cation containing brines.

The present invention involves the use of green non-toxic biodegradable strong alkali metal salts of polymerized weak acids in the tertiary oil recovery compositions and process and provides many advantages over the prior art. The present invention is especially suitable for any tertiary oil recovery applications where alkali is preferred yet the contamination of the environment or the economics of the process could present a problem. For example, in the recovery of oil from offshore or from inland lakes and waterways, or where the use of produced water containing divalent cations is preferred over water softening. Since the proposed green non-toxic biodegradable strong alkali metal salts of polymerized weak acids in the present invention have chelating properties, and solid dispersing properties, they can be used in waters that contain moderate quantities of divalent and other cations such as those formed from Ca, Mg, Fe, Sr or Ba. Furthermore, unlike EDTA, we have unexpectedly found that less than a 1:1 molar-to-molar ratio of the green non-toxic biodegradable strong alkali metal salts of polymerized weak acids to the divalent cations is required to provide the chelating and solids dispersing properties needed. This offers a great economic advantage over many other chelating agents. The proposed green non-toxic biodegradable strong alkali metal salts of polymerized weak acids in the present invention also have pH elevating properties that can be used in the tertiary recovery process to replace inorganic alkali. Thus, the compositions and the process of the present invention that include the green non-toxic biodegradable strong alkali metal salts of polymerized weak acids have all the advantages of inorganic alkali yet eliminates the need of softening waters containing divalent cations and the inherent cost of equipment for softening and disposal of the sludge from such a softening process, or transporting higher quality water from remote locations. Indigenous water can be used rather than securing and transporting higher quality water from remote locations. Also the green non-toxic biodegradable strong alkali metal salts of polymerized weak acids in the present invention offers the advantage of being derived from renewable resources rendering it a green product. In addition it is compatible with polymers and surfactants offering additional cost savings and performance advantages.

It is also widely known that the same formulations used to remove oil from subterranean reservoirs can also be employed to produce low IFT against oils and chlorinated hydrocarbons present in contaminated soils and are very effective in removing such contaminants. The advantage of the present invention is that it employs green non-toxic biodegradable strong alkali metal salts of polymerized weak acids to enhance the IFT and reduce adsorption of the surfactants used to remove the contaminants. For example, U.S. Pat. No. 5,376,182 describes the use of surfactant for soil remediation to remove heavy hydrocarbons and chlorinated hydrocarbons. The soil is freed from these contaminants using a solution containing sodium silicate, an anionic surfactant and an oxidizing agent such as hydrogen peroxide.

### BRIEF SUMMARY OF THE INVENTION

The present invention involves compositions for recovering oil from subterranean oil-bearing formations comprising:

a) a green non-toxic biodegradable strong alkali metal salt of polymerized weak acids,

b) one or more surfactants,

c) an aqueous solvent,

d) optionally one or more mobility control agents, and;

e) optionally one or more co-solvents.

The present invention also involves a process for the recovery of oil from a subterranean oil-bearing reservoir by injecting the compositions consisting of a green non-toxic biodegradable alkali salt of polymerized weak acids, one or more surfactants, an aqueous solvent, optionally one or more mobility control agents, and optionally one or more co-solvent into one or more injection wells and recovering the oil from one or more producing wells. The injection well and the producing well may be the same well.

The primary object of the present invention is to include a green non-toxic biodegradable strong alkali salt of a polymerized weak acid in compositions and processes for recovering oil from subterranean oil-bearing reservoirs.

Another object of the present invention is to have a green non-toxic biodegradable strong alkali metal salt of a polymerized weak acid that can be used in the ASP, AS, and alkali floods that provides equivalent or better oil recovery than conventional inorganic alkali.

Another object of the present invention is to eliminate the need and costs for a water softening process that is necessary or preferred to lower or remove divalent cations from the injection brines when using conventional inorganic alkali.

Another object of the present invention is to save on the up-front investment necessary for a water treatment process and the associated costs of water softening chemicals, disposal, and the ongoing maintenance required for the softening process when conventional inorganic alkalis are used.

Another objective of the present invention is to provide green non-toxic biodegradable strong alkali salts of polymerized weak acids that are compatible with the surfactants and polymers generally used in the tertiary oil recovery processes.

Another objective of the present invention is to eliminate or reduce the use of inorganic alkali and thus eliminate the interaction of inorganic alkali with polymers and surfactants. Another object of the present invention is to provide a green non-toxic biodegradable strong alkali metal salt of polymerized weak acid that will not cause corrosion of the injection equipment and the producer equipment that often occurs when using inorganic alkali. Yet another object of the invention is to prevent scale formation that usually occurs in the reservoir when conventional inorganic alkalis are used.

Other objects and advantages of the present invention will become apparent from the following descriptions, taken in connection with the accompanying examples, wherein, by way of example, an embodiment of the present invention is disclosed.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention involves compositions for recovering oil from the subterranean oil-bearing reservoir where such compositions include a green non-toxic biodegradable strong alkali metal salt of polymerized weak acids, one or more surfactants, an aqueous solvent, optionally one or more mobility control agents, and optionally one or more co- solvent. The present invention also includes a process of recovering crude oil from subterranean oil-bearing reservoirs using such compositions by injecting such compositions into one or more injection wells and producing the oil from one or more producing wells. The injection and producing well may be the same.

The same compositions can be used to remove heavy hydrocarbons and chlorinated hydrocarbons from contaminated soils by contact of the composition with the contaminants.

Green non-toxic biodegradable strong alkali metal salts of polymerized weak acids include salts formed by reacting a polymerized weak acid with a strong alkali. Polymerized weak acids include, but are not limited to, polylactic acid and polyaspartic acid. Strong alkalis include, but are not limited to, sodium hydroxide, potassium hydroxide, sodium carbonate, potassium carbonate, sodium silicate, and potassium silicate.

An especially effective example of a green non-toxic biodegradable strong alkali metal salts of polymerized weak acids is the sodium salt of polyaspartic acid. We have unexpectedly found that this product meets all the requirements as an alkali for enhanced oil recovery purposes as well as having the additional advantages of being non-toxic, biodegradable, made from renewable resources (green) and is easily incorporated into field injection fluids either as a solid or a pre-diluted aqueous liquid. Polyaspartic acid, sodium salts are available commercially from LanXess under the trade names Baypure® DS 100 solid, DS 100/40% liquid and DS 100 solid G. These products are polyaspartic acids having the structure shown below:

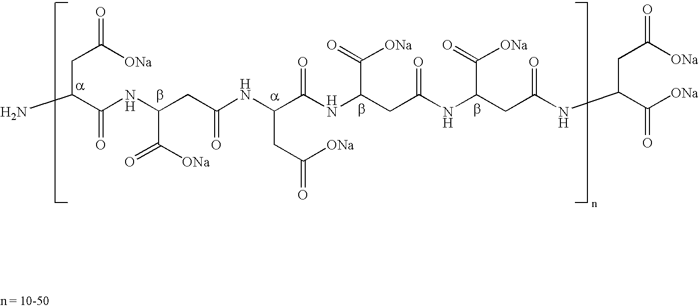

Surfactants that are suitable for this invention include one or more anionic, nonionic or amphoteric surfactants generally known to the art to be effective in reducing the IFT between the injection brine and the residual oil. Cationic surfactants may also be used but are usually found to be less effective and more costly. Some particularly effective anionic surfactants are the sodium salts of alkylbenzene sulfonates, alkyl xylene sulfonates, alkyl toluene sulfonates, alkoxylated alkylphenol sulfonates, alkoxylated alkylphenol sulfonates, alkoxylated linear or branched alcohol sulfates, alkoxylated linear or branched alcohol sulfonates, alkyl diphenylether sulfonates, sulfonated alpha-olefins, and alkoxylated mono and di phosphate esters. Nonionic surfactants include alkoxylated alkylphenols, alkoxylated linear or branched alcohols, and alkyl polyglucosides. Amphoteric surfactants include betaines, sulfobetaines, amidopropyl betaines, and amine oxides. One or more surfactants are used in concentrations of from about 0.025 to about 5.0% by weight of the total injection fluid. An IFT of less than 1×10⁻¹ mN/m is generally preferred to overcome the capillary forces trapping the oil in the pores of the reservoir.

Aqueous solvents that are suitable for the invention include water, solutions of water containing various salts such as oilfield injection brines and produced brines as well as synthetic brines.

The mobility control agent is used to increase the viscosity of the injection fluid to provide a favorable mobility ratio between the injection fluid and the oil. Generally the viscosity of the injection fluid is preferred to be equal or greater than that of the viscosity of the oil at the downhole temperature. Mobility control agents include, but are not limited to, synthetic and natural polymers such as polyacrylamide, partially hydrolyzed polyacrylamide, xanthan gum, hydroxymethyl cellulose and guar gum. Viscoelastic surfactants may also serve the dual purpose of providing mobility control and IFT lowering properties. Mobility control agents are generally used in concentrations from about 0% to about 1% by weight of the total injection fluid.

The co-solvent can be used to enhance the properties and to help solubilize the other ingredients in the composition. Co-solvents include, but are not limited to, low molecular weight alcohols, glycols, and ethers such as iso-propanol, iso-butanol, hexanol, 2-ethylhexanol, ethylene glycol monobutyl ether, ethylene glycol, propylene glycol, diethylene glycol. The co-solvents are generally used in concentrations from about 0% to 20% by weight of the total injection fluid.

The composition described above is injected into one or more injection wells and the oil is produced from one or more producing wells or from the same injection wells.

For treatment of soil that has been contaminated with heavy hydrocarbon or chlorinated hydrocarbon, the composition is brought in contacted with the contaminants either by a similar process as described above involving injecting into an injection well and recovering from a producing well after which the contaminants are separated from the aqueous phase by processes known to those skilled in the art. The contaminated soil may also be excavated and brought into physical contact with the composition allowing the contaminants to pass into the aqueous phase after which the soil is separated from the aqueous phase and returned to its original site while the contaminants are recovered from the aqueous phase. The aqueous phase may then be reconstituted and reused to treat additional contaminated soil. Other additives such as oxidizing agents may be added to the composition to accelerate biodegradation and/or oxidation of the contaminants.

### EXAMPLES

This examples illustrate that inorganic alkali may replaced by green non-toxic biodegradable strong alkali metal salts of polymerized weak acids in a composition for the recovery of oil and that the substitution gives equivalent or superior oil recovery results without the disadvantages of the necessity of softening the injection water to prevent equipment corrosion and scale formation.

Table 1 shows the composition of the synthetic softened brine and synthetic unsoftened brine used for the laboratory tests. These brines simulated the actual brines that are to be used in the field.

TABLE 1
Brine Composition

| Material | Unsoftened Brine, mg/l | Softened Brine, mg/l |
|---|---|---|
| NaCl | 2,131 | 2,502 |
| KCl | 79 | 79 |
| CaCl2—2H20 | 161 | 0 |
| MgCl2—6H20 | 1,087 | 0 |
| Na2SO4 | 381 | 381 |

Table 2 shows the injection fluid compositions used for testing. Inorganic alkali and the green non-toxic biodegradable strong alkali metal salt of polymerized weak acids are used in the formulation to compare their effect on IFT and oil recovery.

TABLE 2
Injection Fluid Compositions

| Ingredient | Description | Concentration | |
|---|---|---|---|
| Surfactant | ORS-47HF ™ | 0.1% | by wt. |
| Alkali or alkali | Na₂CO₃ or NaOH or Baypure ® | 0.4%-1.2% | by wt. |
| substitute | DS-100/40% or Baypure ® DS | | |
| | 100 solid | | |
| Polymer | Flopaam ™ 3630S | 0.1% | by wt. |

| | | |
|---|---|---|
| Brine | As shown in Table 1 | balance |

Notes:
ORS-47HF is an alkylarylsulfonate supplied by Oil Chem Technologies, Inc.
Baypure ® DS-100/40% and Baypure ® DS-100 solid are polyaspartic acid, sodium salt supplied by LanXess.
Flopaam ™ 3630S is a partially hydrolyzed polyacrylamide supplied by SNF Floerger.

Table 3 compares the IFT and oil recovery properties of the inorganic alkali versus green non-toxic biodegradable strong alkali metal salts of polymerized weak acids to show the unexpected oil recovery improvements using the composition of the present invention. The crude oil was collected from a field in North America with API Gravity of 21.2. The interfacial tensions were measured at 65° C. using a University of Texas Model 500 spinning drop interfacial tensiometer. The IFT of the oil and brine without any additives was 25.7 mN/m.

Table 3 demonstrates that the IFTs were comparable for all formulations whether inorganic alkali or green non-toxic biodegradable alkali metal salts of polymerized weak acids were used. However, softened brine is required when using inorganic alkali such as sodium hydroxide and sodium carbonate because calcium and magnesium ions present in the unsoftened brine react with the sodium carbonate and sodium hydroxide to form insoluble calcium carbonate and magnesium carbonate or insoluble calcium hydroxide and magnesium hydroxide. The green non-toxic biodegradable strong alkali metal salts of polymerized weak acids, for example, Baypure® DS100/40% and Baypure® DS100 solid can be used in both softened and unsoftened brines. Furthermore, the data demonstrates the uniqueness of the green non-toxic biodegradable strong alkali metal salts of polymerized weak acids to synergistically work with surfactant to provide low IFT and better oil recovery.

The percent original oil in place (OOIP) recovered was measured by preparing identical sand packed columns for each test as is commonly employed in the industry. Each of the sand packs were saturated with 32% oil and the brine was pumped through the bottom of each of the sand packed columns until all the free oil was removed from the sand pack. 0.3-pore volume of each injection fluid composition was then pumped through the bottom of the separate sand pack columns to determine the residual oil removed by each composition. Unexpectedly, the oil recovery data showed that Baypure® DS100/40% and Baypure® DS100 solid provide superior oil recovery even at much lower concentrations as compared to sodium hydroxide and sodium carbonate.

Table 4 shows the effect of inorganic alkali and the green non-toxic biodegradable strong alkali metal salts of polymerized weak acids on the viscosity using 0.10% Flopaam™ 3630S polymer in the softened brine and unsoftened brine described in Table 1.

The data from Table 4 shows that the hardness of the water affects the viscosity of the brine containing polymer even without inorganic alkali. The addition of 1% Na₂CO₃ or NaOH further reduced the viscosity of the brine containing polymer. However, using 0.4% Baypure® DS 100 solid in place of the inorganic alkali retained the viscosity in the softened brine and the unsoftened brine. From these results it can be seen that the substitution of the green non-toxic biodegradable strong alkali metal salts of polymerized weak acids not only provides the alkalinity required for optimizing the IFT with the surfactant, it also stabilizes the viscosity in the unsoftened water providing a great economic advantage over inorganic alkali in oil recovery processes

TABLE 3
Comparison of IFT and oil recovering properties using inorganic alkali
and the green non-toxic biodegradable strong alkali metal salts of
polymerized weak acids

| | | | | | IFT, mN/m, | Oil Recovery, |
|---|---|---|---|---|---|---|
| Test No | Wt % Alkali | Brine | pH | Appearance | 65° C. | % OOIP |
| 1 | 1.2% Na₂CO₃ | Softened | 12.3 | No | 0.0089 | 20.3 |
| | | | | Precipitates | | |
| 2 | 1.2% Na₂CO₃ | Unsoftened | 11.6 | Precipitated | — | — |
| 3 | 1.0% NaOH | Softened | >13 | No | 0.0063 | 21.5 |
| | | | | Precipitates | | |
| 4 | 1.0% NaOH | Unsoftened | >13 | Precipitated | — | — |
| 5 | 1.0% Baypure ® | Softened | 10.6 | No | 0.0058 | 22.7 |
| | DS100/40% | | | Precipitates | | |
| 6 | 1.0% Baypure ® | Unsoftened | 10.6 | No | 0.005 | 22.3 |
| | DS100/40% | | | Precipitates | | |
| 7 | 0.4% Baypure ® | Softened | 10.5 | No | 0.0052 | 23.1 |
| | DS100 solid | | | Precipitates | | |
| 8 | 0.4% Baypure ® | Unsoftened | 10.6 | No | 0.0058 | 22.2 |
| | DS100 solid | | | Precipitates | | |

TABLE 4
Effect of water and alkali on viscosity
Polymer: 0.1% Flopaam ™ 3630S

| | Softened Water | Unsoftened Water |
|---|---|---|
| 1% Na₂CO₃ | 11.3 cps | 4.7 cps |
| 1% NaOH | 9.3 cps | 2.7 cps |
| 0.4% Baypure ® DS 100 | 14.6 cps | 13.8 cps |
| None | 14.6 cps | 6.8 cps |

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A composition for recovering oil from subterranean oil-bearing formations comprising:
a) green non-toxic biodegradable strong alkali metal salt of polymerized weak acids,
b) one or more surfactants,
c) an aqueous solvent,
f) optionally one or more mobility control agents, and;
g) optionally one or more co-solvents.

2. The composition of claim 1 where the green non-toxic biodegradable strong alkali metal salt of polymerized weak acids is the sodium or potassium alkali metal salt of a polymerized weak acid.

3. The composition of claim 1 where the preferred green non-toxic strong alkali metal salt of a polymerized weak acid has the following structure where n is 10 to 50.

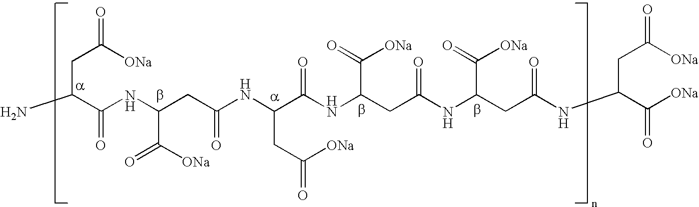

4. The composition of claim 1 where the green non-toxic biodegradable strong alkali metal salt of polymerized weak acids is used from about 0.01% to about 5.0% by weight of the total composition.

5. The composition of claim 1 where the surfactant is one or more from the group anionic, cationic, amphoteric surfactant.

6. The composition of claim 1 where the surfactant is used from about 0.025% to about 5.0% by weight of the total composition.

7. The composition of claim 1 where the aqueous solvent is water, water-alcohol solutions, solutions of various salts in water such as oilfield injection brines and produced brines as well as synthetic brines.

8. The composition of claim 1 where the mobility control agent is one or more synthetic or natural polymers such as polyacrylamide, partially hydrolyzed polyacrylamide, xanthan gum, hydroxymethyl cellulose and guar gum.

9. The composition of claim 1 where the mobility control agent is used from about 0% to about 1% by weight of the total composition.

10. The composition of claim 1 where the co-solvent is a low molecular weight alcohol, glycol or ether.

11. The composition of claim 1 where the co-solvent is used from about 0% to about 20% by weight of the total composition.

12. A process for recovering oil from subterranean oil-bearing reservoirs by injecting a composition containing green non-toxic biodegradable strong alkali metal salt of polymerized weak acids, one or more surfactants, an aqueous solvent, optionally one or more mobility control agent, and optionally one or more co-solvents into one or more injection wells and recovering the oil from one or more producing wells.

13. The process for recovering oil from subterranean reservoirs of claim 12 where the green non-toxic biodegradable strong alkali metal salt of polymerized weak acids is the sodium or potassium alkali metal salt of a polymerized weak acid.

13. The process for recovering oil from subterranean reservoirs of claim 12 where the green non-toxic biodegradable strong alkali metal salt of polymerized weak acids has the following structure where n is 10 to 50:

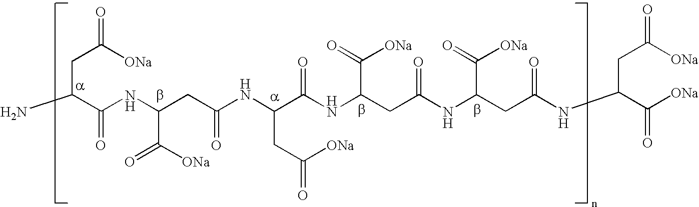

14. The process for recovering oil from subterranean reservoirs of claim 12 where the green non-toxic biodegradable strong alkali metal salt of polymerized weak acids is used from about 0.01% to about 5.0% by weight of the total composition.

15. The process for recovering oil from subterranean reservoirs of claim 12 where the surfactant is one or more from the group anionic, cationic, amphoteric surfactant.

16. The process for recovering oil from subterranean reservoirs of claim 12 where the surfactant is used from about 0.025% to about 5.0% by weight of the total composition.

17. The process for recovering of oil from subterranean reservoirs of claim 12 where the aqueous solvent is water, water-alcohol solutions, solutions of various salts in water such as oilfield injection brines and produced brines as well as synthetic brines.

18. The process for recovering oil from subterranean reservoirs of claim 12 where the mobility control agent is one or more synthetic or natural polymers such as polyacrylamide, partially hydrolyzed polyacrylamide, xanthan gum, hydroxymethyl cellulose and guar gum.

19. The process for recovering oil from subterranean reservoirs of claim 12 where the mobility control agent is used from about 0% to about 1% by weight of the total composition.

20. The process for recovering oil from subterranean reservoirs of claim 12 where the co-solvent is a low molecular weight alcohol, glycol or ether.

21. The process for recovering oil from subterranean reservoirs of claim 12 where the co-solvent is used from about 0% to about 20% by weight of the total composition.

22. The process for recovering oil from subterranean reservoirs of claim 12 where the surfactant is capable of lowering the interfacial tension between the composition and oil to values below 10⁻¹ mN/m in the presence of the green non-toxic biodegradable strong alkali metal salts of polymerized weak acids.
